(19) United States
(12) Patent Application Publication
(10) Pub. No.: US 2007/0073928 A1
(43) Pub. Date: Mar. 29, 2007

(54) High-speed input/output signaling mechanism using a polling CPU and cache coherency signaling

(76) Inventors: John Bruno, Davis, CA (US); Loris Degioanni, Davis, CA (US)

Correspondence Address: MATHEW J. TEMMERMAN, 423 E. STREET, DAVIS, CA, 95616, US

(21) Appl. No.: 11/528,287

(22) Filed: Sep. 26, 2006

Related U.S. Application Data
(60) Provisional application No. 60/720,994, filed on Sep. 26, 2005.

(51) Int. Cl. G06F 3/00

(52) U.S. Cl. 710/46

(57) ABSTRACT

Applicant's high-speed input/output signaling mechanism makes exclusive use of one or more processors (CPU) for polling. Device-bound perpetual polling is initiated neither by the device nor by the processing application: it takes place independently from them, on a CPU exclusively reserved for that task. Another aspect of the present invention is that communication with the I/O device is through the use of “DMA descriptors” that reside in the main memory of the system. In an alternative embodiment, a special purpose device that lacks the full architecture of a typical CPU may play the role of the exclusive polling CPU.

This application claims the benefit of U.S. Provisional Application Ser. No. 60/720,994, filed Sept. 26, 2005.

### BACKGROUND OF THE INVENTION

1. Field of the Invention

This invention relates to methods of inpuVoutput (I/O) signaling, specifically a high-speed mechanism for signaling.

2. Description of the State of the Art

There are two traditional approaches used to interface with a device: interrupt-based notification and application-based polling. In the field of computer science, polling refers to the active sampling of the status of device, I/O status, memory location etc.

The interrupt-based notification method uses an asynchronous interaction mechanism. The most significant aspect of asynchronous communications is that the transmitter and receiver are independent and are not synchronized. Interrupt-based notification is the standard method used by operating systems to receive notifications from devices. An interrupt is initiated by the I/O device. FIG. 1 shows the traditional flow diagram of an interrupt-based system.

As shown in FIG. 1, the list of operations that take place during interrupt-based I/O is the following: 1) the device transfers data through the I/O bus (usually PCI/PCI-X/PCI-Express) to or from the host memory, using bus-master DMA and when completed, the device sends an interrupt signal to the processor; 2) the interrupt signal causes the processor to stop normal execution, switch its context, flush its execution pipeline and jump to the Interrupt Service Routine (ISR) where the ISR acknowledges the interrupt and schedules a lower-priority software IRQ; and 3) the software IRQ (Soft IRQ) finishes interaction with the board and signals the user level application that new data is available (or that a transmit buffer is empty, i.e., the transmission is complete) for Application Processing.

The advantages to interrupt-based device handling are that it is simple to implement, both in the driver and in the device. Moreover, in low-bandwidth/non-critical situations it grants reasonable responsiveness, good latency and efficient CPU usage from the application standpoint.

On the other hand, with medium/high data transfers the interrupt mechanism has high overhead, because of frequent reloading of internal processor tables like Translation Look-aside Buffers (TLBs), the inefficient use of the CPU pipeline and the CPU instruction cache and poor locality that results in a high amount of data cache misses. Moreover, CPU usage by the high priority ISR is unbounded. This can lead to a problem known as livelock, wherein the system spends all its time processing interrupts, to the exclusion of other necessary tasks. Livelock is a condition that occurs when two or more processes continually change their state in response to changes in the other processes. The result is that none of the processes will complete. In a full livelock situation, it is possible that no packets are actually delivered to the application.

Several variations of the interrupt handling mechanism have been proposed, the common goal of which is to reduce the number of interrupts. Examples of variation include inserting a delay in the device before issuing the interrupt signal, so that more data is accumulated for the DMA transfer; disabling the interrupts from the device while the software IRQ is running, and handling multiple packets inside the software IRQ. All these techniques reduce the problems described in the previous paragraph, but do not eliminate any of them.

Moreover, interrupt mitigation trades responsiveness with throughput: delaying or decreasing the number of interrupts has a negative impact when short reaction times are required, or when real-time operations like time stamping are needed.

The second traditional approach used to interface with a device is application-based polling, wherein unlike interrupt-based device management, I/O processing is initiated by the application. The traditional flow diagram of a polling-based system is shown in FIG. 2. The list of operations is the following: 1) when ready to initiate the I/O process, the application programs the device for the next I/O operation and starts the device polling operation; 2) the CPU loops checking one or more I/O registers or memory locations (memory locations can be in the RAM or in device memory which was mapped into the CPU address space) and the device updates when done; and 3) the device transfers data through the bus (usually PCI/PCI-X/PCI Express) to or from the host memory, using bus-master DMA. The device changes the value of the memory location(s) that the CPU is polling (or changes a status register in the I/O memory space). The CPU stops polling and returns to the application. The application processes the received data (or creates new data to transmit) before starting the I/O procedure again.

Polling has a less critical impact on CPU caches and pipelines compared to using interrupts, and does not suffer from the livelock problem mentioned above. Therefore, it is more suitable in high bandwidth situations. However, application-based polling has some serious drawbacks including being highly inefficient from the CPU usage point of view, because it completely blocks the application until new data is available from the device. Moreover, polling the device negatively impacts the other processes that may be currently running on the machine. In addition, responsiveness is usually poor, because during the data processing the application cannot respond to any events produced by the I/O device. The application and the polling loop still compete for caches and CPU pipelines. This competition has negative effects on performance. Finally, polling is very inefficient with more than one device, because the CPU resources spent polling a device are not available to the other devices and applications. Several applications polling at the same time negatively affect cache and CPU pipeline performance.

The problems outlined above are not mitigated in a multiprocessor environment. The problems with locality increase and in the case of multiple polling applications, increasing amounts of CPU resources are devoted to polling.

This technique, although simple to implement, is difficult to fine tune: the polling interval heavily impacts on responsiveness and CPU efficiency, and the precise tuning parameters vary widely from application to application. The priority of the device polling block impacts on the other processes in ways that are difficult to predict. Therefore, application-based polling is difficult to use in practical situations.

There is thus is a need to provide a method for interfacing with a device under medium to high bandwidth situations without high system overhead, that does not raise the likelihood of livelock occurring, and that is efficient from a CPU usage point of view. Applicant's device solves the above problems and minimizes the negative effects on overall system performance.

### BRIEF DESCRIPTION OF THE DRAWINGS

FIG. 1 shows a simplified diagram of a prior art interrupt-based I/O system.

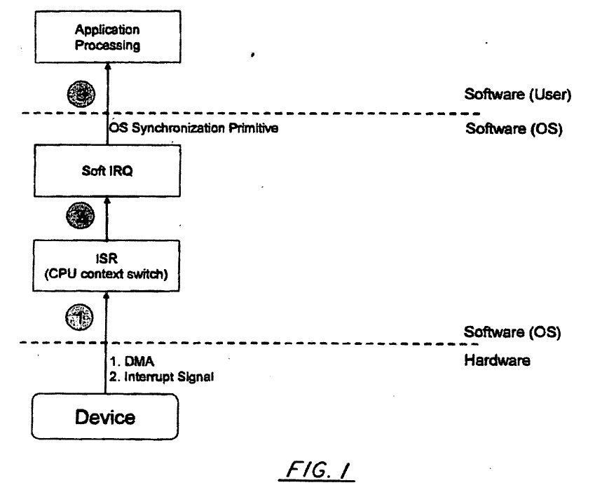

FIG. 2 shows a simplified diagram of a prior art application-based polling I/O system.

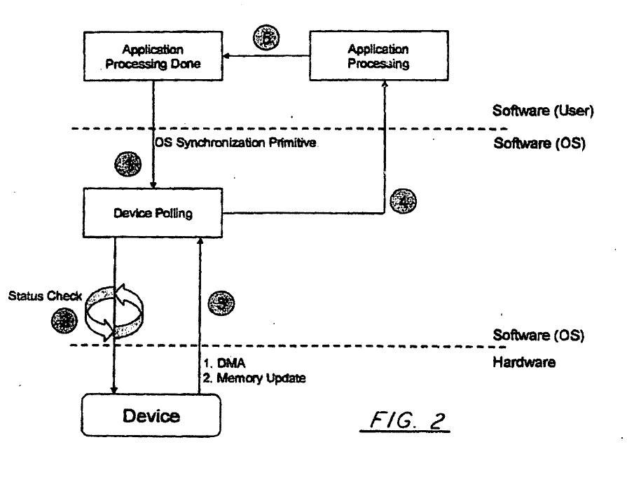

FIG. 3 shows a simplified diagram of a device bound perpetual polling method.

FIG. 4 shows a simplified diagram of a receive-side embodiment of a device bound perpetual polling method.

FIG. 5 shows a simplified diagram of a transmit-side embodiment of a device bound perpetual polling method.

FIG. 6 shows a simplified diagram of an embodiment of a DMA descriptor.

### DETAILED DESCRIPTION OF THE INVENTION

For the purposes of the present invention, the following terms and definitions shall be applied:

DMA: Direct Memory Access, it allows certain hardware subsystems within a computer to access system memory for reading and/or writing independently of the CPU. The CPU or the hardware subsystem may initiate the transfer. In either case, the initiated device does not execute the transfer itself.

CPU: Central Processing Unit

ISR: Interrupt Service Routine: a callback subroutine in an operating system or device driver whose execution is triggered by the reception of an interrupt.

Software IRQ: routine for completing the servicing of an interrupt, with a priority lower than ISR but higher than normal processes.

Livelock: Situation where the rate of interrupts exceeds the system's ability to process the interrupts. The system behaves as if it were deadlocked since there is not enough CPU resource to do anything but service interrupts.

SMP: Symmetric Multi Processor system: The goal of an SMP system is to allow greater utilization of thread-level parallelism.

Cache: Local (to CPU) copy of instruction memory, data memory, or virtual memory translation tables.

TLB: Translation Lookaside Buffer: A buffer in a CPU that contains parts of the page table that translate from virtual into physical addresses. The TLB references physical memory addresses in its table. The TLB may reside between the CPU and the cache, or between the cache and primary storage memory. For example, some processors store the most recently used page-directory and page-table entries in on-chip caches called TLBs.

MESI: A cache coherency and memory coherence protocol. MESI processors providing cache coherence commonly implement this protocol—where the letters of the acronym represent the four states of a cache line, the four states being: Modified (the cache line is present only in the current cache, and has been modified from the value in the main memory—the cache is required to write the data back to main memory at some time in the future, before permitting any other read of the no longer valid main memory state), Exclusive (the cache line is present only in the current cache, but matches main memory), Shared (Indicates that this cache line may be stored in other caches of the machine), and Invalid (indicates that this cache line is invalid).

Processor Affinity: a feature of the operating system scheduling algorithm that permits the binding of a process or thread to a subset of the machine's CPUs. The process or thread will be granted to run only on the specified CPUs. Each task (be it process or thread) in the queue has a tag indicating its preferred CPU. Processor affinity takes advantage of the fact that some remnants of a process may remain in one processor's state (in particular, in its cache) from the last time the process ran, and thus scheduling it to run on the same processor the next time could result in the process running more efficiently than if it were to run on another processor.

The device-bound perpetual polling disclosed by the inventors is applicable to multiprocessor systems. In summary, the technique makes exclusive use of one of the processors (CPU) for polling. In the present invention, for example only, this CPU is referred to as the polling CPU. It should be noted that, in a preferred embodiment of the invention, device-bound perpetual polling is initiated neither by the device nor by the processing application: it is taking place independently from them, on a CPU exclusively reserved for that task.

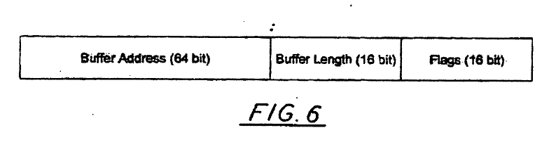

Another aspect of the present invention is that communication with the I/O device is through the use of “DMA descriptors” that reside in the main memory of the system. A DMA descriptor is a data structure that typically contains one or more references to a memory buffer and flags through which the polling CPU and the I/O device communicate. An example of a memory descriptor is shown in FIG. 6. The efficiency and responsiveness of the “signaling path” between the polling CPU and the I/O device makes use of the usual MESI or equivalent cache consistency protocol implemented in an SMP (Symmetric Multiprocessor) system.

In a first embodiment, the present method may be used in a Symmetric Multiprocessor System (SMP) in which it is possible to devote one or more CPUs exclusively to polling. In an alternative embodiment, the present method may be used in I/O devices that use main memory based descriptors for controlling the I/O process. In yet another embodiment, the present method may be used in I/O devices that transfer data using Direct Memory Access (DMA). In yet another embodiment, the present method may be used in a cache consistency protocol (ensures that data stored in a cache is in fact the data of which it purports to be a copy), such as, for example MESI.

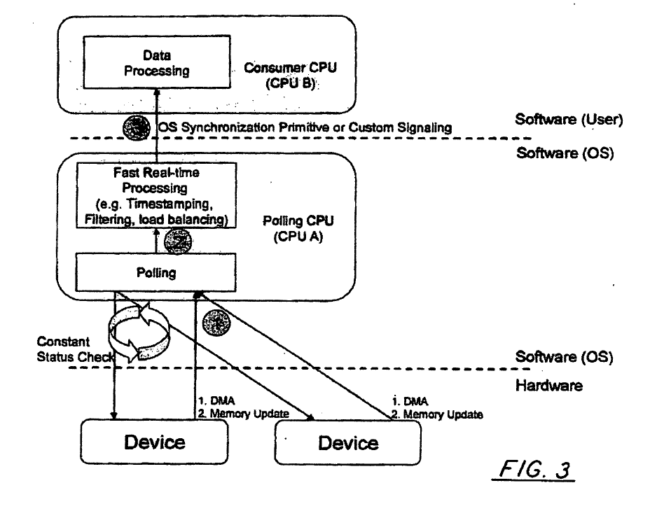

The device-bound perpetual polling technique makes use of the polling CPU for I/O processing. The polling CPU repeatedly polls the device, checking for the availability of new data. As shown in FIG. 3, the Consumer CPU runs the Data Processing application that is expecting to receive data from the I/O devices. For purposes of this patent, this CPU is referred to as the Consumer CPU because it is consuming/processing the incoming data. Through processor affinity techniques, the polling CPU is statically bound to the polling process, perpetually checking the status of the I/O devices. The polling CPU never runs application processes, which as detailed above are run by the Consumer CPU. This means that only the polling CPU has access to the I/O device memory and registers; the polling CPU actually creates a high speed, minimum latency communication path between the device and the user-level application. FIG. 3 shows the polling CPU perpetually checking the status of multiple I/O devices.

Continuing with FIG. 3., in one embodiment of the method, the polling CPU perpetually loops (reads) on the memory area containing the DMA descriptors of one or more devices, essentially checking the for a change of status of an I/O device, that is, whether data is ready to be received or sent. Note that high-speed devices, such as network cards, have DMA descriptors in their RAM, and update them through PCI bus transactions. These transactions are intercepted by the MESI cache coherency system that invalidates the cache lines containing copies of the DMA descriptor in all the machine CPUs. Next, when data is available, the polling CPU optionally performs some limited time critical processing, such as but not limited to timestamp gathering (associating the current time with the incoming data from the I/O device and passing this information to the Data Processing application), filtering (withholding certain incoming data from the Data Processing application), outgoing traffic scheduling, and load balancing of network traffic across different consumer applications should multiple instances be running. Then, the polling CPU signals to the other CPU(s) that new data is available (or that data transmit is finished), using standard operating system primitives, shared memory locations or custom signaling. Note that batching (i.e. signaling the reception of multiple data entities in a single call) can be used to decrease the overhead of this operation. The application has direct access to the buffer with the data coming from the device and therefore, being on a different CPU, is immediately ready to process the data, with warm caches and the proper instructions in the pipeline.

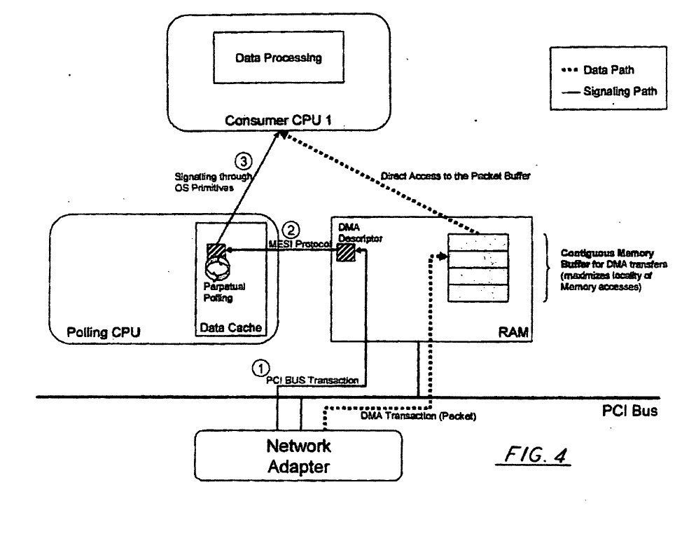

An embodiment of device-bound perpetual polling for receiving packets from a network adapter is shown in FIG. 4. The dashed line arrows show the data path from the I/O device to the Data Processing application, while the sold line arrows show the signaling path, which takes place in three steps: 1) PCI Bus Transaction; 2) MESI protocol cache invalidation; and 3) consumer signaling through standard OS primitives. The data is moved from the Network Adapter to the Memory Buffers in the RAM under DMA controlled by the Network Adapter (no SMP CPU involvement). The Data Processing application moves the data from the Memory Buffers into the Data Processing application. Continuing with FIG. 4, the PCI bus is a standard I/O bus, however, the perpetual polling as described in this application is known to apply to any I/O bus where the I/O devices signals the polling CPU using main memory of the SMP. Although the Cache Consistency Protocol shown in FIG. 4 is MESI, the applicants' disclosure should not be limited to merely the MESI protocol. Regardless of the protocol involved, signaling takes place as the Cache Consistency Protocol invalidates the cache line of the polling CPU that contains the status word of the DMA descriptor.

Unlike interrupt-based systems, signaling is obtained by constantly polling a memory value with the polling CPU. The value contains the memory-resident DMA descriptors for a packet, and is updated by the I/O device using a PCI bus transaction when new data has been transferred to memory and is ready to be processed. If the DMA descriptor doesn't change, the polling CPU has a copy of it in its cache, and therefore the polling process is totally internal to the polling CPU (the instructions of the polling loop are inside the CPU instruction cache too). This means that the polling CPU, even if it's fully loaded, doesn't have any impact on the rest of the system since it uses zero external bus bandwidth.

The PCI bus transaction from the device changes the DMA descriptor and invalidates the cache line. As a consequence, due to the MESI cache coherency protocol, the value is loaded into the cache of the polling CPU and in this way it is “signaled” to both exit from the polling loop and to notify the other CPU(s) that new data is available.

The descriptors are programmed so that the data is moved by the network adapter into physically continuous memory buffers. This simplifies data navigation, speeds-up processing and increases cache coherency. The other CPU(s) normally has/have a direct view of the continuous buffer, to minimize the overhead of copies.

It can be seen that the combination of the PCI bus transaction by the I/O device, the Cache Coherency protocol that updates the cache of the polling CPU, and the polling CPU itself, make up a very low-latency signaling path for communication between the I/O device and the polling CPU.

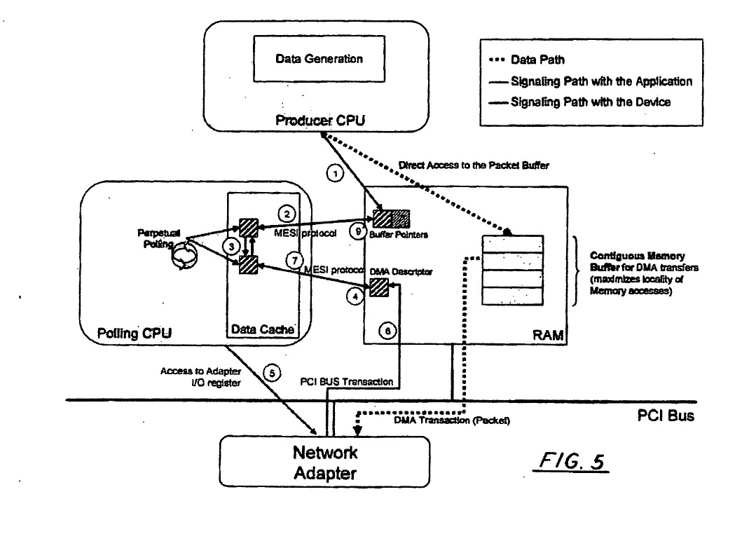

An embodiment of device-bound perpetual polling for transmitting packets from a network adapter is shown in FIG. 5. In FIG. 5, the Data Generation application is running on the Producer CPU. The Producer CPU is so named because the application is creating data that will be sent to the Network Adapter. The Producer CPU and the polling CPU this time share a set of memory locations with their respective positions in the Contiguous Memory Buffer. The perpetual polling this time involves the Buffer Pointer and the DMA descriptor. The sequence of the operations is the following: After moving packets from the Data Generation application into the Contiguous Memory Buffer (as shown by FIG. 5 dotted line), the Producer CPU updates the Buffer Pointers. Next, the MESI protocol cache invalidation “signals” the polling CPU that new data is available in the buffer. As a consequence, the polling CPU updates the DMA descriptors to map the data coming from the Producer CPU. The polling CPU starts Network Adapter activity by writing a register in the Network Adapter's I/O memory. The solid line shown in this Fig. represent the means for the polling CPU to notify the Network Adapter that data is available in the memory buffer. Next, the polling CPU constantly polls on the DMA Descriptors. When the packet has been transmitted, the network adapter updates the corresponding DMA Descriptor. This invalidates the copy of the descriptor in the polling CPU cache, and therefore “signals” the polling CPU that the datum has been transferred. The polling CPU updates the Buffer Pointers, thus communicating to the Producer CPU that the transfer is complete. This communication is performed via the perpetual polling mechanism.

In the case of transmission of data, the polling CPU also communicates with the Data Generation application via the perpetual polling mechanism. In this case, the polling CPU will check for a change in the Buffer Pointer indicating that the Data Generation application has placed new data in the Memory Buffer. The polling CPU perpetually checks the status of the Memory Buffer. When the Data Generation application changes the Buffer Pointers, this is signaled to the polling CPU via the cache coherency protocol.

An observation of the present method shows that the data caches and instruction pipelines are always warm, i.e. the polling CPU has in its cache the device registers and DMA descriptors. The polling CPUs only focus on data, which is organized sequentially for best cache usage. In addition, no context switches happen in the signaling path and the consumer applications. Moreover, the cache coherency protocol signals the CPU very quickly, meaning that the reaction time is much improved over interrupts.

The polling CPU is always polling the devices' DMA Descriptors, therefore the real-time response is excellent. Optionally, the polling CPU can be programmed for simple time-critical tasks like time stamping. The cost of device handling is bounded and known ahead of time. For example, if the workstation has four CPUs and one is used for polling, the cost of device handling is 25% and no livelock is possible.

Because the present method of polling is different from traditional application polling, the polling loop is very simple and decoupled from data processing. Thus, it is easy for the polling loop to handle more than one device without resource conflicts. In addition, if the number of devices and their speed is high, then more than one polling CPU can be used. Moreover, the number of data copies is at a minimum: the only copy of the data is the DMA transfer to or from the device memory from or to the RAM, respectively. No data copies are performed by the CPU. Further, the applications continue to run in parallel with the polling CPU, since the polling CPU operates almost exclusively within its instruction and data caches, the polling CPU has virtually no performance impact on the application CPUs.

The description of this invention up to this point has assumed the availability of a CPU in an SMP system. As the name SMP implies, all of the processors are identical. However, the polling CPU may not need all of the capabilities of a full processor, and, on the other hand, may only need some special features that are appropriate for its role. Thus, in an alternative embodiment of the invention, a special purpose device that lacks the full architecture of a typical CPU may play the role of the “polling CPU”. For example, the polling loop itself could be replaced by circuitry that, using memory coherency protocols like MESI, simply detects the change of one or more memory locations. The polling CPU could have special hardware for generating accurate timestamps on incoming data and filtering capabilities for discarding unwanted incoming data. For outbound data, the polling CPU could have special hardware for controlling when the outbound data is presented to the I/O device's DMA engine, and change a memory location accordingly. This invention is applicable to all devices that are capable of performing all of the steps in the signaling chain from the I/O device to the Data Processing CPUs and vice versa.

The signaling chain for Input consists of first setting up I/O descriptors in memory that describe the location of memory buffers for the incoming data and perpetually polling on the state of the descriptor to determine when the I/O device has completed the transfer of data to the corresponding memory buffer. By “perpetually polling” we are referring to all manner of ways in which the polling CPU can detect that a Write and Invalidate has changed the state of the I/O descriptor. For example, the polling element may have circuitry that detects the change of a memory location without actually executing a program loop. The polling CPU may contain all manner of hardware support for time stamping, filtering that would be executed at this point. Next, the polling CPU updates the I/O descriptors for subsequent I/O operations. Finally, the polling CPU notifies the Data Processing CPU that input data is available.

The polling CPU for Outbound data will poll the descriptors of the I/O device to learn when I/O descriptors become available. The I/O device performs a DMA operation moving the outbound data from Main Memory across the I/O bus to the device. The data processing CPU uses the I/O descriptors to put outbound data in the corresponding buffer. In the case of outbound data, the polling CPU will detect descriptors that have been filled by the data processing CPU and initiate the I/O transfer at the appropriate time. This will allow the polling CPU to “schedule” the outbound data. There may be other functions performed by the polling CPU between the time that the data processing CPU fills the data buffer and the polling CPU schedules the data for transmission.

One skilled in the art will appreciate that the present invention can be practiced by other than the preferred embodiments, which are presented for purposes of illustration and not of limitation.

We claim:

1. A method of using a device-bound perpetually polling system comprising a symmetric multiprocessor system having an input/output component, the method comprising the steps of:
via at least one processor of said multiprocessor system, exclusively polling said input/output component; and
via at least one additional processor of said multiprocessor system, running application processes.

2. The method as recited in claim 1 wherein said exclusively polling comprises:
via the use of DMA descriptors, communication between said at least one processor and said input/output component.

3. The method as recited in claim 2 wherein said communication occurs as a result of a cache coherency protocol change.

4. The method as recited in claim 3 wherein said cache consistency protocol is a MESI protocol and wherein said DMA descriptors are located in cache lines of said at least one processor, the method further comprising:
via said cache coherency protocol, changing said DMA descriptors, invalidating said cache lines; and
signaling from said at least one processor to said at least one additional processor a message that a data portion is available for reading by said at least one additional processor.

5. The method as recited in claim 3 wherein said exclusively polling occurs through processor affinity techniques.

6. The method as recited in claim 3 further comprising:
via said at least one processor, perpetually reading a memory area comprising said DMA descriptors.

7. The method as recited in claim 6 wherein said DMA descriptors refer to memory used for data input/data output of a network card.

8. The method as recited in claim 2 wherein said communication further comprises receiving packets from a network adapter.

9. The method as recited in claim 8 wherein said exclusively polling occurs through processor affinity techniques.

10. The method as recited in claim 8 further comprising:
via said at least one processor, perpetually reading a memory area comprising said DMA descriptors.

11. A method of using a device-bound perpetually polling system comprising a symmetric multiprocessor system further comprising an input/output device, at least one network adapter and an area of memory consisting of DMA descriptors, the method comprising:
via at least one CPU, exclusively perpetually polling said input/output device;
via at least one CPU, perpetually reading said area of memory into said at least one CPU; and
via at least one CPU, running application processes.

12. The method as recited in claim 11 wherein said area of memory comprises DMA descriptors for a packet, the method further comprising:
via said input/output device, updating said DMA descriptors.

13. The method as recited in claim 12 further comprising:
providing main memory based descriptors wherein said main memory based descriptors control said input/output processes.

14. The method as recited in claim 12 further comprising:
moving data from said at least one network adapter into physically continuous memory buffers in said DMA descriptors.

15. The method as recited in claim 14 wherein said multiprocessor system comprises fewer than nine processors.

16. The method as recited in claim 15 wherein said multiprocessor system comprises fewer than three processors.

17. A method of using a device-bound perpetually polling system comprising an input/output device, at least one CPU, a special purpose device, and DMA descriptors, the method comprising:
using said special purpose device solely for device-bound perpetual polling;
constantly polling said input/output device by said at least one CPU;
transferring data through said input/output device; and
communicating with said input/output device through the use of said DMA descriptors.

18. The method as recited in claim 17 further comprising:
providing main memory based descriptors wherein said main memory based descriptors control said input/output processes.

19. The method as recited in claim 17 wherein said input/output devices transfer data using Direct Memory Access.

20. The method as recited in claim 19 further comprising receiving packets from a network adapter.
